(19) United States
(12) Patent Application Publication
(10) Pub. No.: US 2022/0280842 A1
(43) Pub. Date: Sep. 8, 2022

(54) DISPERSED OBJECT COLLECTION APPARATUS AND DISPERSED OBJECT COLLECTION METHOD

(71) Applicant: YAMABIKO CORPORATION, Tokyo (JP)

(72) Inventors: Yoshiharu KOSHIKAWA, TOKYO (JP); EIKI INABA, TOKYO (JP); KENJI NAKANO, TOKYO (JP); YOICHI FUSE, TOKYO (JP); RYOTA YAMADA, TOKYO (JP)

(73) Assignee: YAMABIKO CORPORATION, Tokyo (JP)

(21) Appl. No.: 17/825,358

(22) Filed: May 26, 2022

Related U.S. Application Data
(63) Continuation of application No. PCT/JP2021/004370, filed on Feb. 5, 2021.

(30) Foreign Application Priority Data
Feb. 6, 2020 (JP) 2020-018746

(51) Int. Cl. A63B 47/02; G05D 1/02; G06V 20/50

(52) U.S. Cl. CPC A63B 47/021; G05D 1/0217; G06V 20/50; A63B 2047/022; A63B 69/3694

(57) ABSTRACT

There is provided a dispersed object collection apparatus including an electric machine configured to run by itself along a set running route is an activity area. The machine is caused to start from a collection place and run by itself is a set working area to accommodate dispersed objects dispersed in the working area into an accommodation section provided in or outside the machine and collect the dispersed objects is the collection place. The working area is set as a closed region along outer edges of the dispersed objects in an aggregation region in which a plurality of dispersed objects are close together.

### CROSS-REFERENCE TO RELATED APPLICATIONS

The present application is a continuation application of PCT international application No. PCT/JP2021/004370 filed on Feb. 5, 2021 which claims priority from Japanese Patent Application No. 2020-018746 filed on Feb. 6, 2020, and the entire contents of which are hereby incorporated by reference.

### BACKGROUND

### 1. Technical Field

The present invention relates to a dispersed object collection apparatus configured to collect dispersed objects in a working area while running by itself, and a dispersed. object collection method.

### 2. Related Art

An example of dispersed objects includes balls hit and scattered in a golf practice range. Conventionally, there has been known a self-running hail collection apparatus including a memory configured to store information about ball distribution in a working area, and a processor configured to guide a vehicle into the working area based on the information stored in the memory and collect the balls (see Japanese Patent Application Laid-Open No. 2008-220935). The entire contents of the disclosure are hereby incorporated by reference.

### SUMMARY

The invention provides a dispersed object collection apparatus including an electric machine configured to run by itself along a set running route in an activity area. The machine is caused co start flora a collection place and run by itself in a set working area to accommodate dispersed objects dispersed in the working area into an accommodation section provided in or outside the machine and collect the dispersed. objects in the collection place. The working area is set as a closed region along outer edges of the dispersed objects in an aggregation region in which a plurality of dispersed objects are close together.

### BRIEF DESCRIPTION OF DRAWINGS

FIG. 1 illustrates the working environment of a dispersed object collection apparatus;

FIG. 2 illustrates the equipment configuration of the dispersed object collection apparatus;

FIG. 3 illustrates an operation process of the dispersed object collection apparatus (dispersed object collection method).

FIG. 4A illustrates an example of setting of a working area where an aggregation region is specified;

FIG. 4B illustrates an example of setting of a working area where outermost dispersed objects are specified;

FIG. 4C illustrates an example of setting of a working area where the working area is set;

FIG. 5 illustrates an example of specifying the aggregation region;

FIG. 6 illustrates an example of setting the running route of a machine; and.

FIG. 7 illustrates an example of setting the running route of the machine for a plurality of aggregation regions.

### DETAILED DESCRIPTION

The self-running collection apparatus as the conventional art has a problem to improve the efficiency of the running of the vehicle to collect more dispersed objects for a short time. To address this, the conventional art proposes to run the vehicle based on the information about the distribution of the dispersed objects in the working area, and describes that a location where balls are or may be more highly distributed or more gathered than other locations is designated as the working area to be prioritized

However, about the setting of the working area, the conventional art vaguely describes that it is based on predicted distribution of dispersed objects, or based on monitoring of dispersed condition by a vision sensor, but does not describe a concrete method of setting the working area to reduce the running of the vehicle not performing the collection work as much as possible.

In addition, in a case where the collection apparatus is electrically operated to run the vehicle and perform the work, when a battery equipped in the vehicle is charged during the work, the efficiency of the work is significantly down. Therefore, in order to perform efficient collection work, it is important for the electric collection apparatus to reduce the consumption of the battery as much as possible to reduce the number of times to charge the battery (or avoid charging the battery) during the work.

The more the load of an electric motor is increased, the greater the degree of consumption of the battery is. Therefore, it is not satisfied to reduce the consumption of the battery only by simply reducing the running distance.

The above-described conventional art does not describe the setting of the working area in view of the battery consumption, and therefore has the problem that it is not possible to effectively promote the efficiency of the work when being applied to the electric collection apparatus.

The present invention is proposed to address the above-described problem. It is therefore an object of the invention to present specific measures to improve the efficiency of the collection work of a self-running dispersed object collection apparatus, by reducing the running of a machine not performing the collection work to collect dispersed objects as much as possible, and to effectively promote the efficiency of the work by setting a working area in view of the battery consumption of the electric collection apparatus.

Hereinafter, an embodiment of the present invention will be described with reference to The drawings. The same reference numbers i.n the different drawings indicate the same functional parts, and therefore repeated description for each of the drawings is omitted.

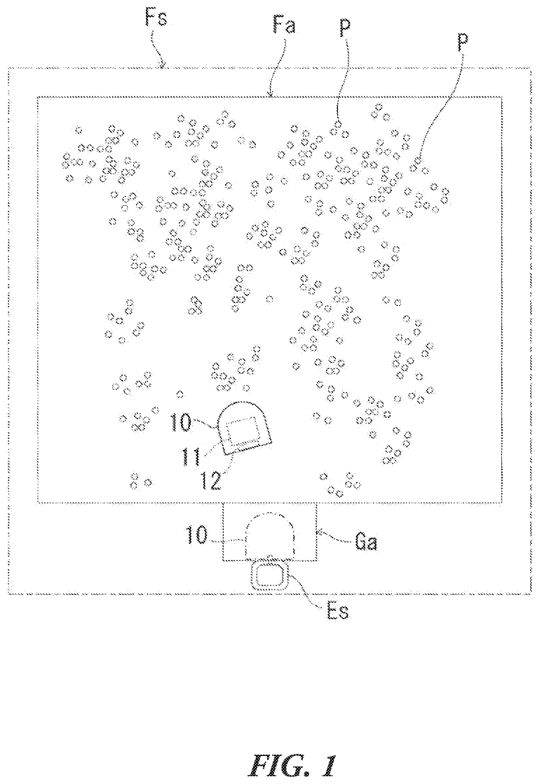

The dispersed object collection apparatus is configured to appropriately set an activity area Fa in a facility zone Fs as illustrated i.n FIG. 1, and collect dispersed objects P dispersed in the activity area Fe by causing a machine 10 to run by itself in the activity area Fa. A collection place Ga is provided outside the activity area Fa in the facility zone Fs. The machine 10 starts from the collection place Ga or another start point, and accommodates the dispersed objects P into an accommodation section 11 provided in or outside the machine 10 in the course of running by itself in the activity area Pa.

After the end of predetermined collection work, the machine 10 returns to the collection place Ga, and discharges the dispersed objects P accommodated in the accommodation section 11 to the collection place Ga. The collection place

Ga is provided with charging equipment Es. The machine 10 is electrically operated, and when the machine 10 returns to the collection place Ga, a battery 12 of the machine 10 is charged by the charging equipment Es.

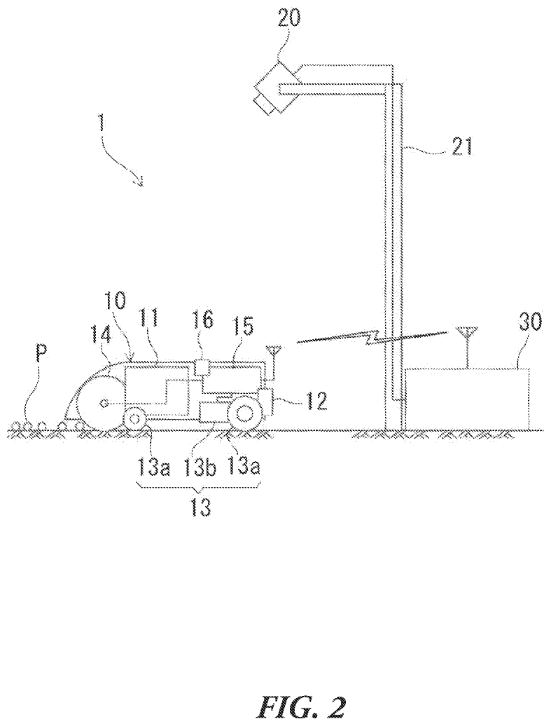

FIG. 2 illustrates the equipment configuration of the dispersed object collection apparatus. A dispersed object collection apparatus 1 includes a machine 10 configured to run by itself in the above-described activity area Fa; a camera 20 configured to look down at part or the whole of the activity area Fa to capture an image of part or the whole of the activity area Fa; and a work instruction transmitter 30 configured to acquire the image captured by the camera 20 and transmit a work instruction to the machine 10.

The machine 10 includes, in addition to the above-described accommodation section 11 and the battery 12, a running part 13 (running wheels 13a and running drive part 13b) configured to run on a field surface of the activity area Fa; a pickup mechanism 14 configure to pick up the dispersed objects P from the field surface and put the dispersed objects P into the accommodation section 11; and a controller 15 configured to control the running part 13 and the pickup mechanism 14 based on an instruction signal received from the work instruction transmitter 30, and a detection signal from a position detector 16 such as a GPS receiver.

The camera 20 transmits the captured image of part or the whole of the activity area. Fa to the work instruction transmitter 30 as needed, regularly, or according to the instruction from a user, depending on the working situation of the dispersed object collection apparatus 1. In addition, the camera 20 can capture an image of a predetermined range of the activity area Fa according to a control signal from the work instruction transmitter 30. In this case, the work instruction transmitter 30 can recognize positional information of the capturing range (angle of view) of the camera 20.

With the illustrated example, the camera 20 is supported by a predetermined support (a pillar, or a wall. surface or a ceiling surface of the facility) 21 in order to look down at the activity area Fa to capture the image of the activity area Fa. However, the camera 20 may be installed in the machine 10. Alternatively, in order to compensate for the blind spot of the camera 20 provided in the facility, the camera 20 provided in the facility and the camera 20 provided in the machine 10 may be used together.

Basically, the work instruction transmitter 30 sets the working area in the activity area Fa; sets a running route through which the machine 10 having started from the collection place Ga (or another place) performs the collection work in the set working area and returns to the collection place Ga; and transmits data of the setting up the machine 10.

With the illustrated example, the work instruction transmitter 30 is provided outside the machine 10, but the controller 15 of the machine 10 may have the function the same as the work instruction transmitter 30. In this case, image information acquired by the camera 20 is transmitted to the controller 15, or image information acquired by an outside camera is previously inputted to the controller 15.

By this means, the controller 15 sets the working area and the running route by itself.

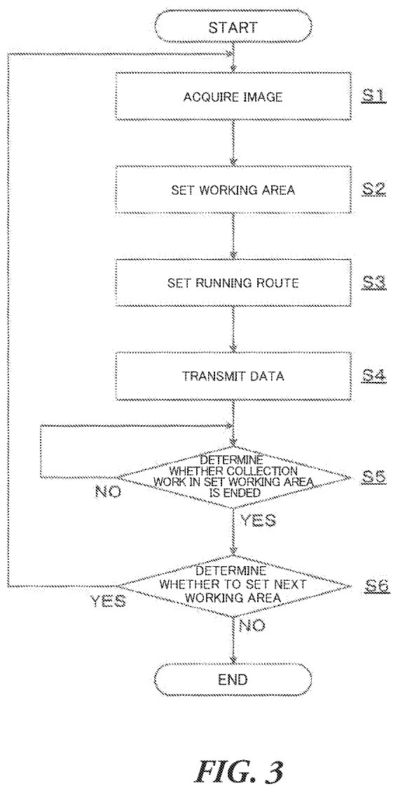

FIG. 3 schematically illustrates an operation process of the work instruction transmitter 30. In a first step (image acquisition step) S1, an image is acquired from the camera 20 to set the working area. The acquired image is an image of the field in the activity area Fa in which dispersed objects are dispersed, and a still image of the set capturing range and positional information of the capturing range are acquired at the same time.

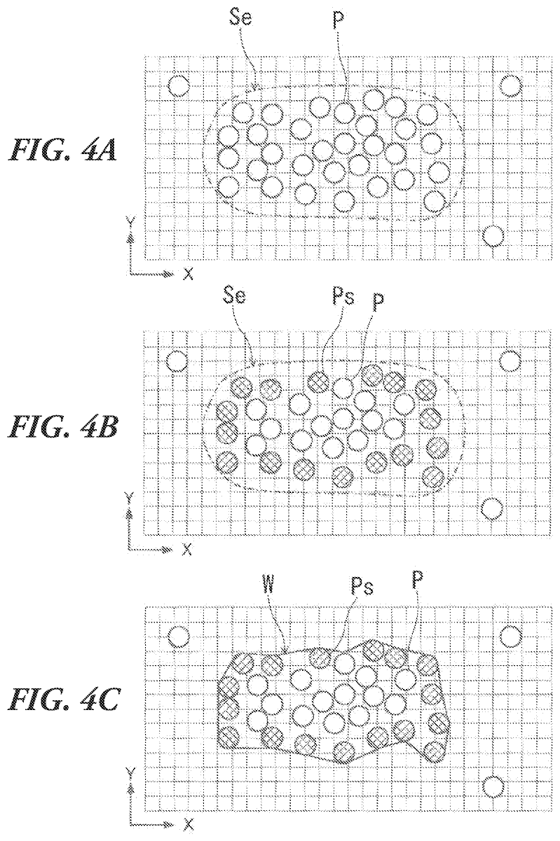

In a second step (working area setting step) S2, the working area is set based on the acquired image. Image processing is applied to the acquired image to distinguish between the image of dispersed objects (such as balls) and the other images (sues: as the background image). Then, as illustrated in FIG. 4A, the positions of the dispersed objects P existing in the acquired image are recognized on a position coordinate (K-Y coordinate) corresponding to the capturing range of the acquired image.

To set the working, area, after the position of each of the dispersed objects P is specified on the position coordinate, an aggregation region Se in which a plurality of dispersed objects are close together is specified as illustrated in FIG. 4A. To specify the aggregation region Se, for example, the position coordinate and the image of the dispersed objects P are displayed on a display screen, a line surrounding the aggregation of the dispersed objects P being close together is inputted by using a predetermined input tool (such as a touch pad, a touch pen, a mouse, and a keyboard.), and a closed region surrounded by the line is specified as the aggregation region. Se.

The aggregation region Se may be set directly as the working area. Moreover, in order to improve the efficiency of the collection work by narrowing down the working area, and reducing the running of the machine 10 not performing the collection work to collect the dispersed objects as much as Possible, the working area is set according to the following process.

In this process, after the aggregation region Se is specified, the dispersed objects P in the aggregation region

Se is specified, and among them, outermost dispersed objects Ps are further specified as illustrated in FIG. 4B. Each of the outermost dispersed objects Ps can be specified as a dispersed object P which has no dispersed object P outside it in one of the X direction and the I direction, which is determined based on the X-Y coordinate position of each of the dispersed objects P in the aggregation region Se. Whether there is a dispersed object P outside it is determined by determining whether there is a dispersed object P outside it within the width (diameter) of the dispersed object P.

When the outermost dispersed objects Ps of the dispersed objects P in the aggregation region Se are specified, a closed region along the outer edge of each of the outermost dispersed objects Ps is set as illustrated in FIG. 4C, and this closed region is set as a working area W. In this way, by setting the working area. H, it is possible to reduce the running of the machine 10 not performing the collection work to collect the dispersed objects P as much as possible, and therefore to improve the efficiency of the collection work. Here, with the illustrated example, the closed region is set to contact the outer edges of the outermost dispersed objects Ps, but may be set to be a little apart from the outer edges of the outermost dispersed objects Ps, or may be set to connect parts such as the centers of the outermost dispersed objects Ps to each other.

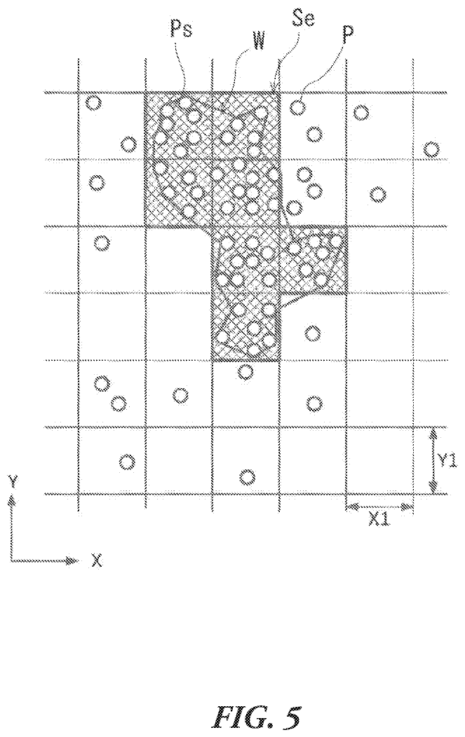

With the above-described embodiment, the aggregation region Se is specified by hand using the input tool. However, in order to perform more efficient collection work, the aggregation region Se is specified by arithmetic processing. In this case, as illustrated in FIG. 5, first, a unit region having width X1 in the X direction and width Y1 in the Y direction is set for the position of each of the dispersed objects P on the above-described position coordinate, and the number of the dispersed objects P in each of the unit regions is counted. Then, the unit regions each having the number of dispersed objects equal to or greater than a set value are connected to form the aggregation region Se. In the illustrated drawing, the set value is equal to or greater than five, and the unit regions with cross-hatching form the aggregation region Sc.

The aggregation region Se with cross-hatching specified as described above can be set directly as the working area W. Meanwhile, as described above, the outermost dispersed objects Ps in the aggregation region Se are specified, and the closed region along the cuter edges of the outermost dispersed objects Ps may be set as the working area W as illustrated in FIG. 5.

In addition, a method to specify the aggregation region Se by the arithmetic processing is not limited to the above-described example. For example, the positions of the dispersed objects P dispersed on the position coordinate are specified, and an aggregation of the dispersed objects in which the distance between two adjacent dispersed objects is equal to or smaller than a predetermined value is specified and may be set as the aggregation region Se.

When the aggregation region Se is specified by the arithmetic processing, the number of the dispersed objects P in the working area W is set to be smaller than the capacity of the accommodation section 11 of the machine 10. When the number of the dispersed objects P in the working area W is greater than the capacity of the accommodation section 11, the machine 10 is returned to the collection place Ga once to discharge the dispersed objects P, and collects the dispersed objects P in the working area P again, and therefore it is not possible to perform efficient collection work.

The working area W is set to allow the efficient correction work by performing the work once. In this case, the size and the location of the aggregation region Se are set to achieve the optimal efficiency, under the conditions such as the traveling distance of the machine 10 and the battery consumption.

As illustrated in FIG. 3, the working area P is set in the second step (working area setting step) S2, and next, the running route of the machine 10 is set in the third step (running route setting step) S3.

In the setting of the running route, a running route of the machine 10 from the collection place Ga (or another start point) to the working area P; a running route of the machine 10 performing the collection work co collect the dispersed objects in the working area W; a running route of the machine 10 moving from one aggregation region Se to another aggregation region Se when a plurality of aggregation regions Se forms the working area hi; and a running route of the machine 10 returning from the working area W to the collection place Ga after the end of the collection work are optimally set in view of the collection efficiency and the battery consumption.

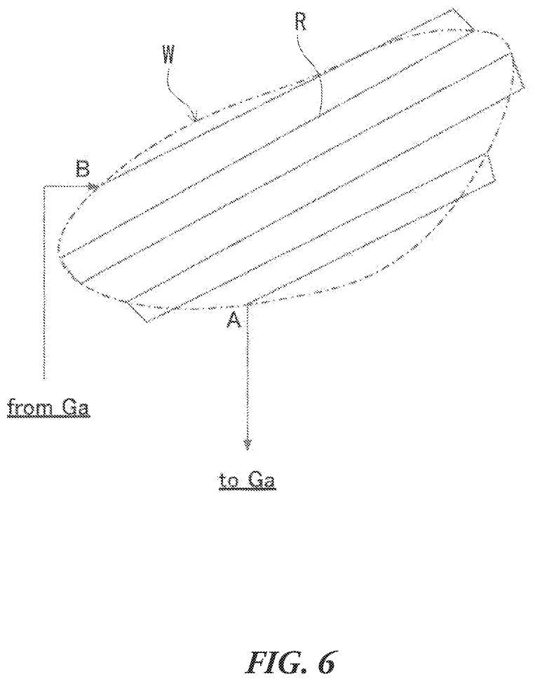

For setting the running route of the machine 10 in the working area W, for example, when the working area hi is long in one direction, a running route R is formed by making turns of a straight line along the longitudinal direction of the working area W as illustrated in FIG. 6. In this way, for the running in the entire working area W, it is possible to reduce the number of turns, and therefore to improve the efficiency of the collection work.

In addition, in a case where priority consideration is given to the battery consumption, when the weight of the machine 10 is increased due to the dispersed objects accommodated in the accommodation section 11, the running route is set to shorten the running distance. For this, for example, the running route is set such that the running distance of the machine 10 from the working area W to the collection place Ga is minimized. With the example illustrated in. FIG. 6, a point B at which the machine 10 enters the working area W is set to be far from the collection place Ga so that a point A at which the machine 10 leaves the working area W is close to the collect on place Ga.

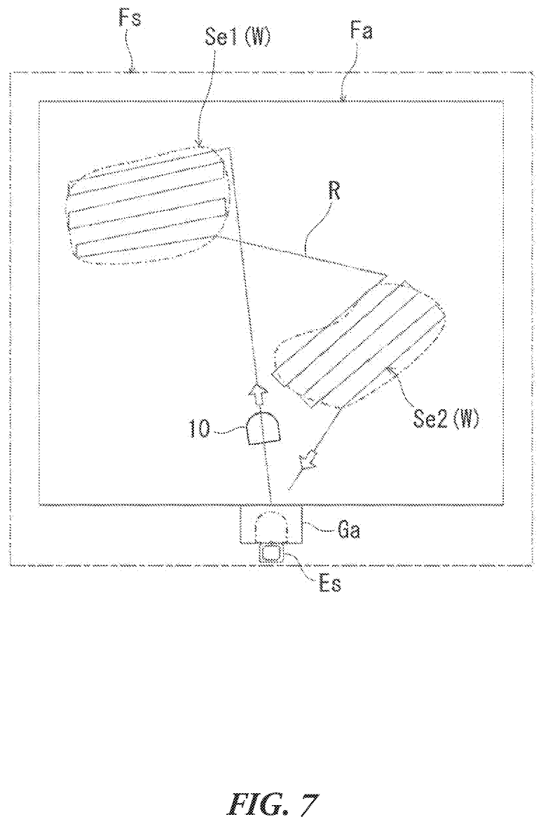

As illustrated in FIG. 7, when a plurality of aggregation regions Se1 and Se2 are specified in locations apart from one another, the running route of the machine 10 is set such that the work is performed first on the working area W in the aggregation region Se1 which is the most far from the collection place Ga, and the work is performed last on the working area W in the aggregation region Se2 which is the closest to the collection place Ga. By this means, it is possible to shorten the running distance of the machine 10 having an increased weight due to the dispersed objects P accommodated in the accommodation section 11, and therefore to suppress the battery consumption.

When a plurality of aggregation regions Se are specified, any of them may be selected to set the working area W. In this case, it is preferred that the aggregation region Se with a high work efficiency is selected based on the distance from the collection place Ga to the aggregation region Se and the number of the dispersed objects in the aggregation region Se, and the working area P is set in the selected aggregation region Se.

Meanwhile, when a plurality of aggregation regions Se are specified, all of them may be set as the working area W. In this case, the priority of the plurality of aggregation regions Se is determined, based on the distance from the collection place Ga to the aggregation regions Se and the number of the dispersed objects in the aggregation regions Se, and the collection work may be performed first on the working area W in the aggregation region Se with a high priority.

The running speed of the machine 10 on the running route may be appropriately set as follows: in view of the collection rate, the running speed is reduced in the working area W; in view of the battery consumption and the working time, the running speed of the machine 10 having the empty accommodation section 11 is increased; and the running speed is reduced when the occupancy rate of the accommodation section 11 is high.

When the running route is set, data of the set working area P and data of the set running route are transmitted from the work instruction transmitter 30 to the controller 15 of the machine 10 in a fourth step (data transmission step) S4 as illustrated in FIG. 3. The controller 15 of the machine 10 controls each of the parts of the machine 10 according to the data transmuted from the work instruction transmitter 30, and performs the collection work to collect the dispersed objects P in the set working area N while causing the machine 10 to run by itself.

Then, the collection work to collect the dispersed objects P in the working area N is continued until is determined that the work is ended (step S5: NO) , and when determining that the work in the working area W is ended (step S5: YES) , the controller 15 transmits a signal to inform the end to the work instruction transmitter 30. After that, the work instruction transmitter 30 determines whether to set the next working area W, and when it is determined to set the next working area N (step S6: YES), the step is returned to the step Si, and the step S1 to the step S5 are performed. On the other hand, when it is determined not to set the next working area W (step S6: NO), the process is ended.

The setting of the working area W in the step S1 may be performed at an appropriate timing. For example, the setting may be performed regularly at a prescribed interval or time, or may be performed optionally by designation of a user. Alternatively, the setting may be performed at the timing when the machine 10 returns to the collection place Ga.

As described above, the dispersed object collection apparatus 1 can properly set the working area W to reduce the running of the machine 10 not performing the collection work to collect the dispersed objects as much as possible, and therefore can improve the efficiency of the collection work. In addition, it is possible to effectively promote the efficiency of the work by setting the working area W and the running route in view of the battery consumption.

The dispersed object collection apparatus 1 can be installed in a facility such as a golf practice range, and can be used to collect balls hit from bays. In this case, even though the bays are occupied, it is possible to perform the collection work to collect balls, and perform efficient collection work. Therefore, it is possible to shorten the period of time until the balls hit from the bays are collected. By this means, it is possible to reduce the stock quantity of the bails in the facility, and consequently to smoothly and economically manage the facility.

However, the dispersed object collection apparatus 1 according to the embodiment of the invention is not limited to the apparatus for the collection work to collect balls.

The dispersed object collection apparatus 1 is applicable to the collection work to collect various kinds of dispersed objects such as harvested crops and grass on an agricultural field, and can perform efficient collection work.

As described above, the embodiments of the present invention have been described in detail with reference to the drawings. However, the specific configuration is not limited to the embodiments, and the design can be changed without departing from the scope of the present invention. In addition, the above-described embodiments can be combined by utilizing each other's technology as long as there is no particular contradiction or problem in the purpose and configuration.

1. A dispersed object collection apparatus comprising an electric machine configured to run by itself along a set running route in an activity, area, the machine being caused to start from a collection place and run by itself in a set working area to accommodate dispersed objects dispersed in the working area into an accommodation section provided in or outside the machine and collect the dispersed objects in the collection place,
wherein the working area is set as a closed region along outer edges of the dispersed objects in an aggregation region in which a plurality of dispersed objects are close together.

2. The dispersed object collection apparatus according to claim 1, wherein the aggregation region is formed by connecting unit regions, each of the unit regions having the number of dispersed objects equal to or greater than a set value.

3. The dispersed object collection apparatus according to claim 1, wherein the aggregation region is set such that a distance between two adjacent dispersed objects is equal to or smaller than a sec value.

4. The dispersed object collection apparatus according to claim 1, wherein the working area is set such that the number of dispersed objects in the working area is smaller than capacity of the accommodation section.

5. The dispersed object collection apparatus according to claim 1, wherein the running route of the machine in the working area is formed by making turns of a straight line along a longitudinal direction of the working area.

6. The dispersed object collection apparatus according to claim 1, wherein the collection place is provided with charging equipment configured to charge a battery of the machine.

7. The dispersed object collection apparatus according to claim 6, wherein the running route of the machine is set such that a running distance of the machine from the working area to the collection place is minimized.

8. The dispersed object collection apparatus according to claim 6, wherein:
the working area is set to be formed by a plurality of aggregation regions apart from each other; and
the running route of the machine is set such that work is performed first on the working area which is the most far from the collection place, and work is performed last on the working area which is the closest to the collection place.

9. The dispersed object collection apparatus according to claim 1, wherein the aggregation region is specified based on a captured image of the dispersed objects dispersed in the activity area.

10. A dispersed object collection method by causing an electric machine configured to run by itself along a set running route in an activity area to:
start from a collection place and;
run by itself in a set working area to accommodate dispersed objects dispersed in the working area into an accommodation section provided in or outside the machine and collect the dispersed objects in the collection place,
wherein the working area is set as a closed region along outer edges of the dispersed objects in an aggregation region in which a plurality of dispersed objects are close together.

11. The dispersed object collection method according to claim 10, comprising:
acquiring a captured image of the dispersed objects dispersed in the activity area; and
specifying the aggregation region based on positions of the dispersed objects in the image.

12. The dispersed object collection method according to claim 10, comprising:
acquiring a captured image of the dispersed objects dispersed in the activity area;
counting the number of the dispersed objects for each of unit regions in the image;
specifying an aggregation region formed by connecting the unit regions each of which has the number of the dispersed objects equal to or greater than a set value; and
setting the working area based on positions of the dispersed objects existing is the aggregation region.
